(19) United States
(12) Patent Application Publication
(10) Pub. No.: US 2024/0146531 A1
(43) Pub. Date: May 2, 2024

(54) MOBILE IDENTIFICATION TECHNIQUES

(71) Applicant: Apple Inc., Cupertino, CA (US)

(72) Inventors: Hicham Lozi, Fremont, CA (US); Ahmer A. Khan, San Jose, CA (US); Martijn T. Haring, Utrecht (NL); Yannick L. Sierra, San Francisco, CA (US)

(73) Assignee: Apple Inc., Cupertino, CA (US)

(21) Appl. No.: 17/976,649

(22) Filed: Oct. 28, 2022

(51) Int. Cl. H04L 9/32; H04L 9/30

(52) U.S. Cl. CPC H04L 9/32; H04L 9/30

(57) ABSTRACT

Techniques are described herein for mobile document provisioning. An example method includes a device receiving, from an inspection system of a first jurisdiction, a request for a mobile identification document of a second jurisdiction. The device can transmit, to the inspection system, the mobile identification document based on the request, the mobile identification document comprising a mobile identification document public key. The device can receive from the inspection system, a mobile supplemental document, the mobile supplemental document comprising a mobile supplemental document public key derived from the mobile identification document public key, the inspection system being configured to derive the mobile supplemental document public key from the mobile identification document public key. The device can derivate a mobile supplemental document private key that corresponds to the mobile supplemental document public key, the derivation of the mobile supplemental document to private key linking the mobile supplemental document to the mobile identification document.

### BACKGROUND

Digital documents can include readable content that can be presented to third parties through electronic devices. In a sense, digital documents can be considered paperless replacements of original paper documents. Digital documents can be stored on and presented using electronic devices, such as mobile phones or tablets. These digital documents can offer advantages to paper documents, including improving storage capacity, accessibility, organization, and security.

### BRIEF DESCRIPTION OF THE DRAWINGS

FIG. 1 is an illustration of a system for issuance and presentment of travel documents, according to one or more embodiments.

FIG. 2 is an illustration of a data model for mobile documents, according to one or more embodiments.

FIG. 3 is a process flow for authenticating mobile documents on a device, according to one or more embodiments.

FIG. 4 is a process flow for authenticating mobile documents on a device, according to one or more embodiments.

FIG. 5 is a process flow for authenticating mobile documents on a device, according to one or more embodiments.

FIG. 6 is a process flow for authenticating mobile documents on a device, according to one or more embodiments.

FIG. 7 is a process flow for authenticating mobile documents on a device, according to one or more embodiments.

FIG. 8 is an illustration of a data exchange of passport documents between a device and an inspection system, according to one or more embodiments.

FIG. 9 is an illustration of data elements for a mobile passport (mPass), according to one or more embodiments.

FIG. 10 is an illustration of a security mechanism for a mobile travel document, according to one or more embodiments.

FIG. 11 is an illustration of a request and response sequence for travel documents, according to one or more embodiments.

FIG. 12 is a process flow for linking a mobile travel record to a mobile passport, according to one or more embodiments.

FIG. 13 is a block diagram of a mobile device, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As technology is allowing people to control more and more aspects of their lives through their devices, people simultaneously want to manage more of their interactions with third parties using their devices. One area in our daily lives that can be impacted by technological advances is traveling. Airline travel and, in particular, international travel can now be accessible to a larger percentage of the population than ever before. Commercial aspects, such as airline tickets, hotel reservations, and car rentals in foreign countries can be handled using electronic devices.

Official travel documents or other identification documents, such as passports, visas, and passport stamps are not available as travel documents that can be electronically stored in a mobile device and presented to a governmental authority. For example, one cannot present an electronic passport to verify age, identity, or enter a foreign jurisdiction. Various issues can arise with electronically stored documents, such as verifying whether the travel documents were generated by a proper governmental authority, verifying whether the governmental authority intended for the travel documents to be provisioned on a particular device, and/or verifying how a reader device authenticates the travel documents.

Embodiments herein address the above-described issues by providing a mobile identification document, such as a mobile passport, on a user device that can be presented to a reader device (e.g., a security terminal device, point of sale device, or the like) for authentication. The reader device can authenticate that the mobile document originated from a proper issuing authority and request additional mobile supplemental documents, such as other mobile travel documents if necessary. For example, the user device can present mobile supplemental documents, such as a visa and other travel records to the reader device. The reader device can further authenticate the mobile visa and other mobile travel records to make an informed decision.

These mobile travel credentials can be composed of a group of mobile documents that can be linked together. For example, the mobile documents can be linked together by using a mobile passport (mPass) identifier. The mobile documents (mDocs) used for travel can include a mobile identification document, such as an mPass, which can be a digital passport issued by an issuing country, and a mobile visa (mVisa) which can be issued by an issuing country. The mPass can be cryptographically linked to the mVisa in a secure location of a user's device. The mDocs can further include travel records (mTRs), which can be issued by an inspection system (e.g., reader device) of a country. The mTRs can include digital passport stamps, as digital passports cannot be stamped by physical means. A user device can store multiple mTRs depending on how many countries the user has visited. Each mTR can be cryptographically linked to the mPass as well. As described herein, the mPass can be considered a parent document and the mVisa and mTR can be considered child documents. Although this disclosure refers to passports, visas, and passport stamps, the travel documents can include other documents required for entry into a foreign jurisdiction, such as work permits, resident cards, etc., or even other documents that can be used to identify a user (e.g., a concert entry ticket, bus pass, or the like).

The embodiments are described in relation to a mobile passport (mPass), a mobile visa (mVisa), and mobile travel records (mTR). It should be appreciated that the techniques related to the embodiments described below (e.g., key derivation, linking) can be applied to other mobile documents (mDocs) as well. For example, vaccination cards, access credentials, identity credentials, loyalty credentials, insurance cards, property ownership and registration documents, and other appropriate mobile documents. In these instances, the mobile identification document can be a primary form of identification and the mobile supplement documents can be additional documents (e.g., vaccination cards, access credentials, identity credentials, loyalty credentials, insurance cards, property ownership and registration documents) that can be linked to the mobile identification document.

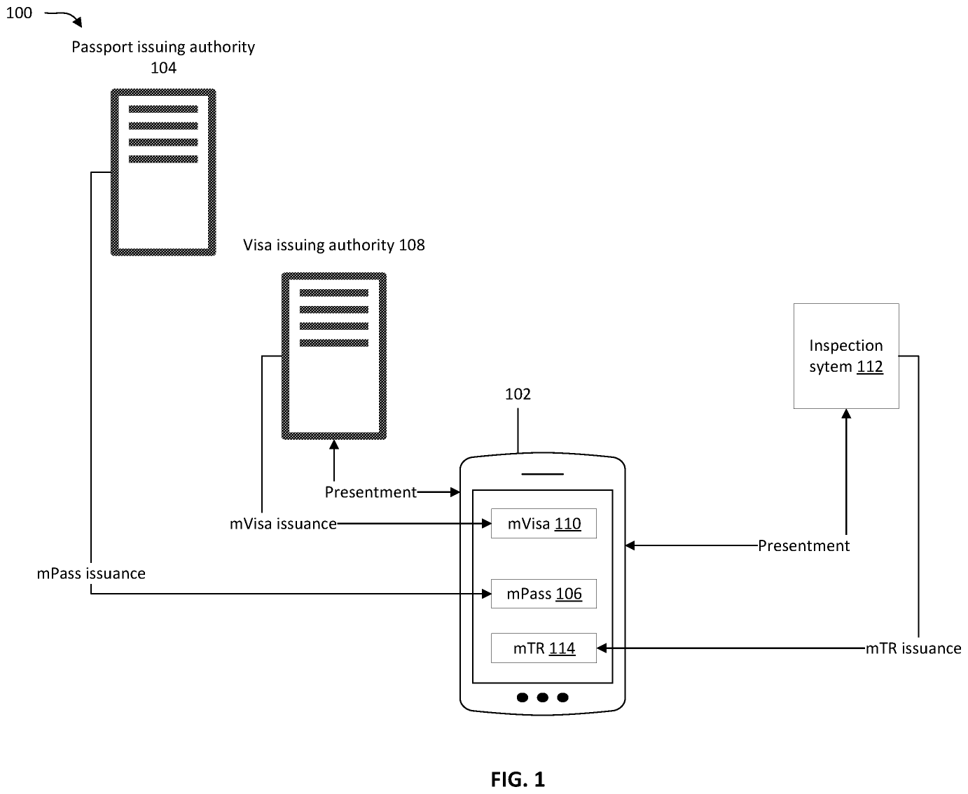

FIG. 1 illustrates a system 100 for issuance and presentment of travel documents, according to one or more embodiments. A mobile device 102 can be a portable device that can be carried by a single individual. The mobile device 102 can be operable to exchange information with another device without a wired connection. The mobile device 102 can include permanent and ephemeral local data storage and a self-contained power source. The mobile device 102 can include one or more methods (e.g., a display, a speaker, vibration actuator) to convey information to a user. The user can be an “mDoc holder” (to whom the mDoc is issued) as defined by ISO/IEC 18013-5. The mobile device 102 can further include a means for a user to interact with the device (e.g., touch screen, button, motion sensors).

The mobile device 102 can store one or more mDocs (e.g., mVisa, mPass, mTR), where an mDoc can be as defined by ISO/IEC 18013-5. The mobile device 102 can communicate with a passport issuing authority 104, which upon presentment of the appropriate documentation can provision an mPass 106 on the mobile device 102. The mPass 106 can represent a mobile digital version of an electronic passport. The mobile device 102 can further communicate with a visa issuing authority 108, that upon presentment of proper documentation can provision an mVisa 110 onto the mobile device 102. In general, the passport issuing authority can be a governmental authority, and the visa issuing authority 108 can be a governmental authority.

The mobile device 102 can further communicate with a reader 112 (e.g., mDoc reader). The reader can be a device that can retrieve an mDoc for verification purposes as defined by ISO/IEC 18013-5. The reader 112 can be located at a border (e.g., port) or the functional equivalent of a border (e.g., airport). A user can use the mobile device 102 to present the mPass 106 and, if necessary, the mVisa 110 to the reader 112. The reader 112 can communicate with the mobile device 102 to authenticate the mPass 106 and, if needed, the mVisa 110. In response to authentication, the reader 112 can provision the mobile device 102 with an mTR 114. For example, the reader 112 can provision the mobile device 102 with a digital stamp similar to an ink stamp on a physical passport. The mPass 106, the mVisa 110 and the mTR 114 can be cryptographically linked by for example, by using an identifier of a parent document (e.g., mPass). In this sense, a subsequent reader can verify that each of the mDocs (mPass 106, mVisa 110, and mTR 114) were provisioned to the same holder as the parent document holder (e.g., mPass). The device reader can further use anti-cloning mechanisms as described in ISO/IEC 18013-5 (e.g., digital signatures and medium access control techniques) to verify that the mDocs are being presented by the mobile device to which they were issued. In some instances, a user can have more than one passport (e.g., dual citizen). In many instances, a user can travel to more than one foreign jurisdiction and can have multiple issued visas. Additionally, the user can accumulate more than one mTR as the user passes from one foreign jurisdiction to another. The mobile device 102 is operable to store multiple instances of mDocs and to cryptographically link each of the mDocs.

The reader 112 can include an inspection system that can request, receive, and verify the integrity and the authenticity of the mPass 106, the mVisa 110, and/or the mTR 114 whether or not the online connectivity is available for either the mobile device 102 or the reader 112. Furthermore, the reader 112 can perform its functions without any relation to the passport issuing authority 104 or the visa issuing authority 108.

The mobile device 102 and the reader 112 can communicate using an interface, which can support selective disclosure of information and data minimization. In this sense, neither device is provided more information than required to present and authenticate the mDocs. The user can use the mobile device 102 to present one or more mDocs and/or receive an mTR without having to handover the device. In other words, the user can grasp the mobile device 102 in their hand and move the device close enough to the reader 112 to initiate a secure session to exchange information. The mobile device 102 can further be configured to allow the user to authorize the presentment of one or more mDocs. For example, the mobile device 102 can include a display that provides a prompt as to whether the user wants to present one or more mDocs to the reader 112.

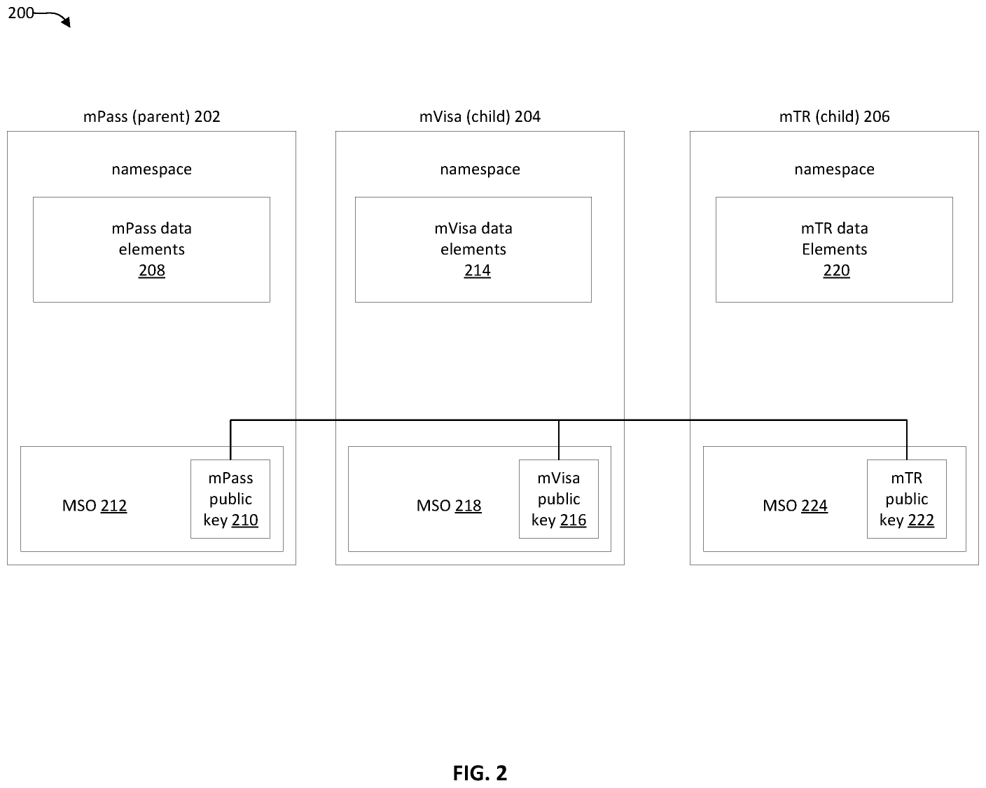

FIG. 2 is an illustration 200 of a data model for mobile documents, according to one or more embodiments. As illustrated, a mPass 202, an mVisa 204, and an mTR 206 can be provisioned onto a mobile device, such as mobile device 102 of FIG. 1. The mPass 202 can include a set of mPass data elements 208, which can include holder name, date of birth, address, telephone passport issuing authority, passport number, and other appropriate information. The mPass data elements 208 can be arranged in groups known as namespaces, as described in ISO/IEC 18013-5. For example, the mPass data elements 208 can include biometric data, such as a facial image, a fingerprint, an iris scan. The biometric data can be grouped together using a biometric related namespace, such as “holder biometrics”. Another grouping can be an emergency contact information—such as contact name, address, and telephone number. The emergency contact information can be grouped together using a namespace, such as “person to notify”. Each data element of the mPass data elements 208 can be cryptographically signed using an mPass issuer public key. The mPass public key 210 can be stored in a secure location, described as a “secure area” by ISO/IEC 18013-5. A reader (e.g., reader 112) can use an interface to retrieve and authenticate the mPass public key 210.

The mVisa 204 can include a set of mVisa data elements 214. The mVisa data elements 214 can include, for example, the holder's name, name of visa issuing authority, visa document number. Similar to the mPass 202, the mVisa data elements 214 can be separated into groups and identified by namespaces. Each data element of the mVisa data elements 214 as well as the mVisa public key 216 can be cryptographically signed by the mVisa issuer private key. An mVisa public key 216 can be included in the Mobile Security Object (MSO) 212, where an MSO is as described in ISO/IEC 18013-5. A reader (e.g., reader 112) can use an interface to retrieve the mVisa data elements 214 and the mVisa public key 216 and verify their signature using the mVisa issuer public key. A reader (e.g., reader 112) can use an interface to verify the trustworthiness of the mVisa issuer public key.

The mTR 206 can also include a set of mTR data elements 220. The mTR data elements 220 can include, for example, the holder's name, name of mTR issuing authority, mTR document number. Similar to the mPass 202 and the mVisa 204, the mTR data elements 220 can be separated into groups and identified by namespaces as described in ISO/IEC 18013-5. Each data element of the mTR data elements 220 can be cryptographically signed using a mTR issuer public key. A reader (e.g., reader 112) can use an interface to verify the trustworthiness of the mTR issuer public key.

The mPass 202, an mVisa 20, and a mTR 206 can be linked using a process of key derivation, wherein key derivation can include using a key derivation function (KDF) to generate one or more keys using a master key (e.g., mPass public key 210). A mobile device, such as mobile device 102 of FIG. 1 can also store an mPass private key that corresponds to the mPass public key 210. The mPass private key can be known only to the mobile device and also stored in the secure area. In the instance that a visa issuing authority provisions an mVisa on the mobile device, it can further generate the mVisa public key 216 using a KDF that can be described as an asymmetric elliptic curve key derivation, and the mPass public key 210 as a parent key. The visa issuing authority can further include the mVisa public key in the MSO 218. Additionally, the mobile device can generate an mVisa private key using the key derivation function used to derive the mVisa public key and the mPass private key as a parent key. Therefore, although the mVisa public key 216 is known to the visa issuing authority, the corresponding mVisa private key is not known to the visa issuing authority. Similarly, if an authority provisions the mobile device with an mTR 206, the authority can create the mTR public key 222 using a KDF and the mVisa public key 216 as a parent key. In turn, the mobile device can use a KDF and the mVisa private as a parent key to generate the mTR private key. Again, the mTR issuing authority can know the mTR public key 222, but only the device can know the mTR private key.

A reader, such as the reader 112 of FIG. 1, can inspect the mDocs provisioned in a mobile device using various methods. For example, the reader can use a “forward engagement” or a reverse engagement”. In some embodiments, the reader can use sequential requests to request each mDoc that is needed to complete a transaction. For example, if a user is attempting to enter a foreign jurisdiction, the reader can first request an mPass, and then, if the mPass is authenticated, request an mVisa, then, if the mVisa is authenticated, request a first mTR, and so forth. Therefore, the user can present the requested mDoc to the reader, wait for authentication of the mDoc, and then keep presenting a subsequently requested mDocs until the authentication process is complete. In other embodiments, the reader can transmit a modified message to the mobile device that requests all required mDocs in a single request. For example, if the reader needs to see both an mPass and an mVisa, rather request both mDoc separately, request both mDocs through the modified message.

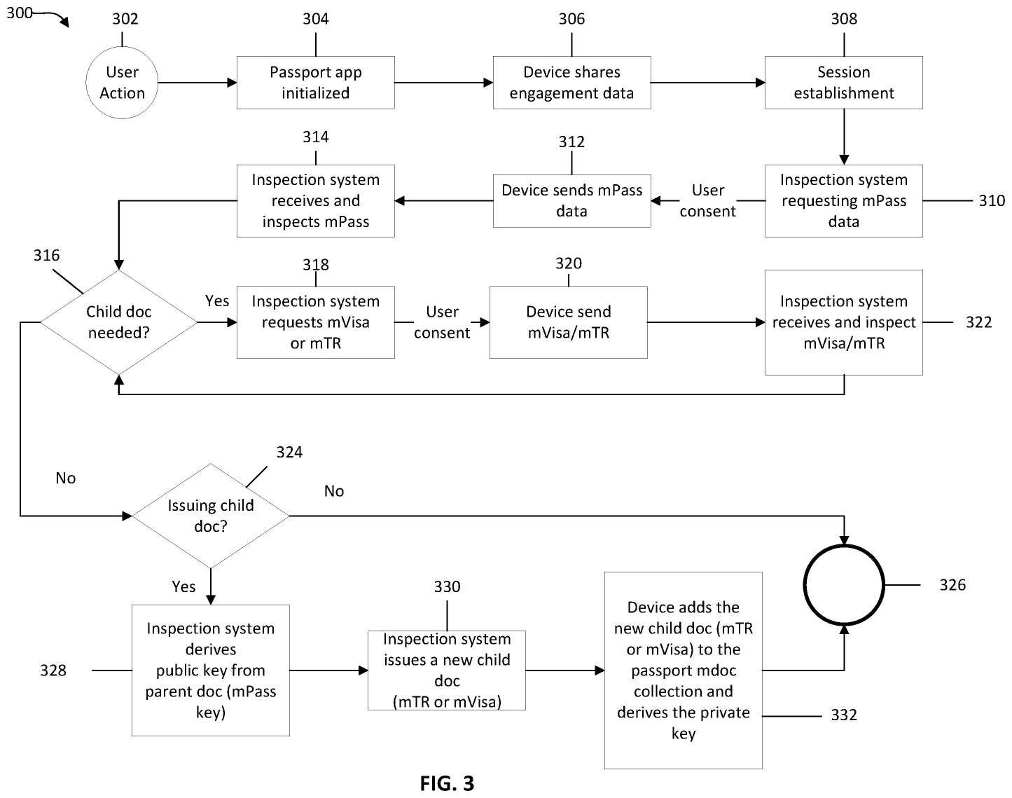

FIG. 3 is a process flow 300 for authenticating mobile documents on a device, according to one or more embodiments. While the operations of processes 300, 400, 500, 600, 700, and 1200 are described as being performed by generic computers, it should be understood that any suitable device (e.g., a mobile device, a reader device) may be used to perform one or more operations of these processes. Processes 300, 400, 500, 600, 700, and 1200 (described below) are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIGS. 3-5 related to a forward engagement, which can be optimal for in-person presentation of mDocs, in which proximity protocols such as near field communication (NFC), Bluetooth, and Wi-Fi can be used. In general, a user action can activate a passport application on a device, the device and an inspection system can share engagement data regarding transmission methods and how to setup a secure session as defined by ISO/IEC 18013-5. The user action can be, for example, be a near field communication (NFC) tap or QR code scan. The devices can further exchange information using mDoc requests and mDoc responses. The mDoc requests can indicate whether a requested document is critical (e.g., necessary for entry into jurisdiction) or conditional (e.g., optional for entry into a jurisdiction). The mDoc request can further indicate that a value of a data element must equal or a certain value or can indicate that the value of the data element must equal one of a set of values.

At 302, the user can perform an action for initializing a passport application on a device, such as the mobile device 102 of FIG. 1. The action can be, for example, using a touch screen to manually touch a passport application icon displayed on the device. The device and the inspection system can both be equipped with short-range communication technology, such as NFC technology, radio frequency identification (RFID), Wi-Fi, or Bluetooth technology. After touching the passport application icon, the user's device and inspection system can detect one another based on the proximity and can open a secure session between one another.

At 304, the passport application can be initialized based on the user's action at 302. In some instances, the passport application can be displayed on the device based on the initialization. By initializing the passport application, the application can shift from a sleep state to an awake state to perform its functions.

At 306, the device and the inspection system can share engagement data. The engagement data can be exchanged pursuant to a short-range transmission protocol and used by the device and the inspection system to identify one another. For example, the device and the inspection system can exchange engagement data necessary to perform, for example, a handshake authentication, a challenge-response authentication, a password authentication, or other information to validate one another.

At 308, the device and the inspection system can establish a secure session. Both the device and the inspection system can include encryption protocols, such that any information to be transmitted is encrypted prior to transmission.

At 310, the inspection system can request mPass data from the device. The request can be in the form of an encrypted message transmitted by the inspection system to the device over the secure channel.

At 312, the device can send the mPass data to the inspection system. In some embodiments, the device can be configured to require user consent prior to providing the mPass data. The consent can be received, for example, by displaying a prompt asking the user for consent to share the mPass data with the inspection system.

At 314, the inspection system can receive the mPass data, where the mPass data can be a mobile passport and considered a parent document. The inspection system can receive the mPass data from the device over the secure channel.

At 316, the inspection system can determine whether a child document is required. For example, some jurisdictions require an additional mDoc (e.g., visa, work permit) in addition to a passport to enter. This mDoc can be considered a child document to the parent document.

At 318, if the inspection does require child document, the inspection system can send a message to the device requesting the additional child document. For example, the inspection system can use the secure channel to send a request to the device for an mVisa.

At 320, the device can send the requested child document to the inspection system. In some embodiments, the device can be further configured to require user consent prior to providing the requested child document. For example, the device can send the requested child document over the secure channel based on receiving a signal indicating user consent.

At 322, the inspection system can receive the requested child document from the device. For example, the inspection system can receive a requested mVisa from the device over the secure channel.

The method then returns to 316, where the inspection system determines whether an additional child document (e.g., mTR) is required. The additional child document can be, for example, a work permit. If the inspection system determines that an additional child document is required, the method repeats steps 318-322 for the additional child document.

If at 316, the inspection system determines that no child documents are needed from the device, the inspection system can determine whether it needs to issue a child document (e.g., child mDoc) to the device. For example, the determination can be “does the inspection system need to issue a passport stamp to the device?”

If the answer to the determination at 324 is no, the inspection system and/or the device can end this process and begin another process at 326.

If, however, the answer to the determination is yes, the inspection system can derive a public key for the child document at 328. For example, the inspection system can use a key derivation function (KDF) and a public key of a parent document to derive a public key for the child document.

At 330, the inspection system can issue the child document (e.g., mTR, mVisa) to the device. For example, the inspection system can transmit the child document to the device over the secure channel.

At 332, the device can add the child document to the mDoc collection stored in a secure location in the device. The child document can be cryptographically linked to the parent document (e.g., mPass). The device can further derive a private key for the child document from the private key of the parent document. The private key can further be stored in the secure location of the device.

Upon deriving the private key for the child document, the inspection system and/or the device can end this process and begin another process at 326.

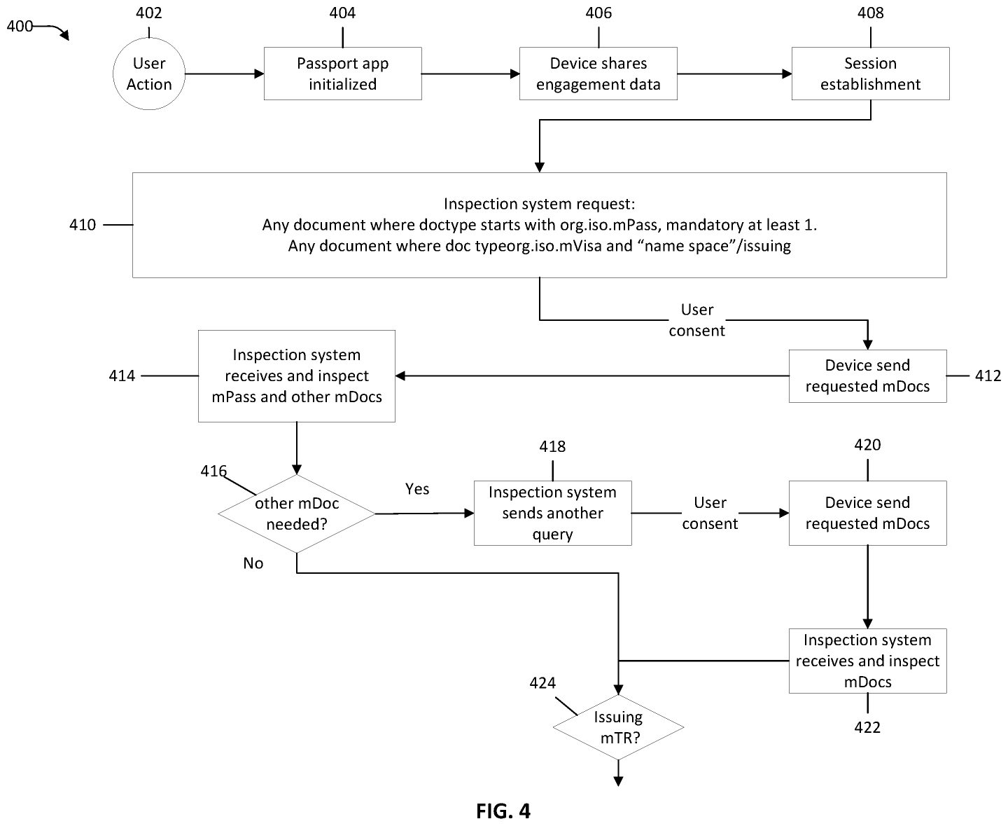

FIG. 4 is a process flow 400 for authenticating mobile documents on a device, according to one or more embodiments. At 402, the user can perform an action for initializing a passport application on a device, such as the mobile device 102 of FIG. 1. The action can be, for example, using a touch screen to manually touch a passport application icon displayed on the device. The device and the inspection system can both be equipped with short-range communication technology, such as NFC technology, RFID, or Bluetooth technology. The user's device and inspection system can detect one another based on the proximity and can open a secure session between one another.

At 404, the passport application can be initialized based on the user's action at 402. In some instances, the passport application can be displayed on the device based on the initialization. By initializing the passport application, the application can shift from a sleep state to an awake state to perform its functions.

At 406, the device and the inspection system can share engagement data. The engagement data can be exchanged pursuant to a short-range transmission protocol and used by the device and the inspection system to identify one another. For example, the device and the inspection system can exchange engagement data necessary to perform, for example, a handshake authentication, a challenge-response authentication, a password authentication, or other information to validate one another.

At 408, the device and the inspection system can establish a secure session. Both the device and the inspection system can include encryption protocols, such that any information to be transmitted is encrypted prior to transmission.

At 410, the inspection system can request all the required mDocs. In other words, rather than make a new determination of a requirement for an additional child document after a parent document is received, the inspection system can be configured to request all the mDocs in a single message. For example, the inspection system can request “Any document where doctype starts with org.iso.mPass, mandatory at least 1” or “Any document where doc type equals org.iso.mVisa and namespace/issuing.” For example, rather than send separate messages to request an mPass and an mVisa (as illustrated in FIG. 3), the inspection system can request both the mPass and the mVisa in a single message.

At 412, the device can send the requested mDocs to the inspection system. For example, if the inspection system requested an mPass and an mVisa, the device can send both mDocs to the inspection system. The mDocs can be cryptographically linked in the device. In some embodiments, the device can be further configured to require user consent prior to providing the requested mDocs. For example, the device can send the requested mDocs over the secure channel based on receiving a signal indicating user consent.

At 414, the inspection system can receive the requested mDocs from the device. For example, the inspection system can receive a requested mPass and mVisa from the device over the secure channel.

At 416, the inspection system can determine whether another mDoc is required. For example, based on the received mDocs, the inspection system can determine that an additional mDoc (e.g., work permit) is required. This mDoc can be considered a child document to the parent document.

If the inspection system determines that another mDoc is required, the inspection system can send another query to the device at 418.

At 420, the device can send the requested mDoc to the inspection system. For example, if the inspection system requested a mobile work permit, the device can send the mobile work permit to the inspection system. The mDocs can be cryptographically linked in the device. In some embodiments, the device can be further configured to require user consent prior to providing the requested mDoc. For example, the device can send the requested mDoc over the secure channel based on receiving a signal indicating user consent.

At 422, the inspection system can receive the requested mDoc from the device. For example, the inspection system can receive a requested mobile work permit from the device over the secure channel.

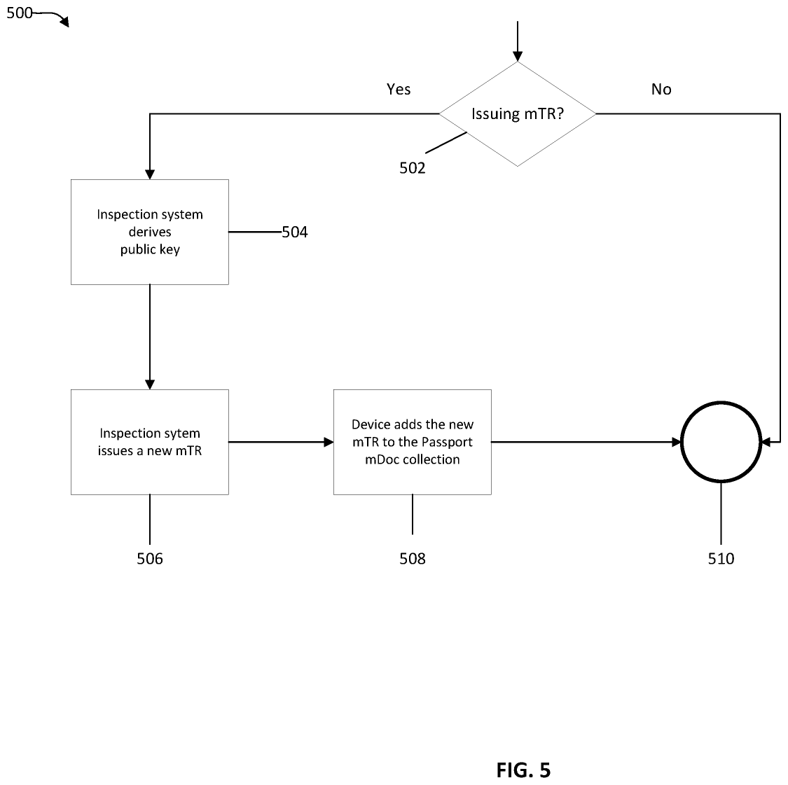

At 424, the inspection system can determine whether to issue an mTR to the device. For example, the inspection system can determine whether to issue a passport stamp to the device. For illustration purposes, the process flow 400 continues on FIG. 5.

FIG. 5 is a process flow 500 for authenticating mobile documents on a device, according to one or more embodiments. At 502, the inspection system can determine whether to issue an mTR to the device. For example, the inspection system can determine whether to issue a passport stamp to the device. It should be appreciated that 502 can be the same step as 424 of FIG. 4.

If the inspection system determines to issue an mTR (e.g., passport stamp), the inspection system can derive a public key for the mTR at 504. For example, the inspection system can use a key derivation function (KDF) and a public key of a parent document to derive a public key for the mTR.

At 506, the inspection system can issue the mTR (e.g., passport stamp) to the device. For example, the inspection system can transmit the passport stamp to the device over the secure channel.

At 508, the device can add the mTR to the collection of passport mDocs. The mDocs can be stored in a secure location on the device. Each of the mDocs can be cryptographically linked in the device. The device can further derive a private key for the mTR. For example, the device can use a KDF and a private key of a parent document to derive a private key for the mTR. The private key can further be stored in the secure location of the device.

At 510, once the device stores the mTR private key or has determined not to issue an mTR at 502, the inspection system and/or the device can end this process and begin another process.

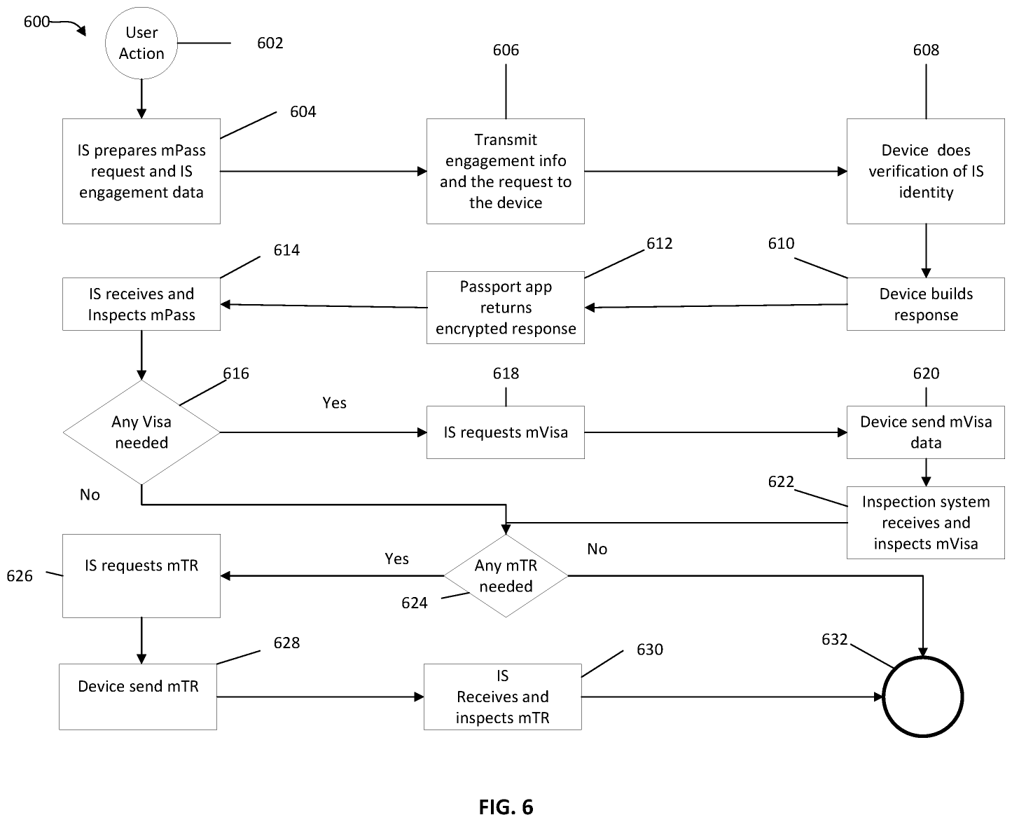

FIG. 6 is a process flow 600 for authenticating mobile documents on a device, according to one or more embodiments. It should be appreciated that where FIGS. 3-6 related to a forward engagement, FIG. 6 relates a reverse engagement, in which the inspection system shares information regarding the secure session setup and requests data from the device. The device can further respond to a request using an mDoc response.

At 602, the user can perform an action for initializing a passport application on a device, such as the mobile device 102 of FIG. 1. The action can be, for example, using a touch screen to manually touch a passport application icon displayed on the device.

At 604, the inspection system can prepare a request for an mPass and prepares inspection system engagement data. The inspection system engagement data can include information for establishing a secure session between the device and the inspection. For example, the engagement data can include information related to a handshake authentication, a challenge-response authentication, a password authentication, or other information to validate one another.

At 606, the inspection system can transmit the engagement information and the request for the mPass to a device. The device can include a passport application executing on the device. The passport application can be operable for storing one or more mDocs used for traveling by a user.

At 608, the device can verify the inspection system's identity. The device can employ a public key infrastructure (PKI) system to verify a reader certificate.

At 610, the device can generate a response to the request from the inspection system. In response to receiving the request from the inspection system, the device can create an mDoc response message that includes the mPass and any necessary key information. For example, the mDoc response can include key information that the inspection system can use to verify the mPass. The device can further encrypt the response using an encryption protocol.

At 612, the device can return the encrypted response to the inspection system. For example, the device can transmit the encrypted mDoc response over the secure channel to the inspection system.

At 614, the inspection system can receive the response from the device and can inspect the mPass. The response can be an mDoc response and include the mPass. The inspection system can inspect the data elements included in the mPass to determine whether the mPass includes any required data elements and it associated with the user and the user device.

At 616, the inspection system can determine whether any mVisa is required.

At 618, the inspection system can send a request for the mVisa from the device. The request can be based on the inspection system determining that the mVisa is required. For example, the inspection can send a second mDoc request to the device. The second mDoc request can be encrypted pursuant to the encryption protocol and transmitted to the device over the secure channel.

At 620, the device can send the mVisa to the inspection system. The mVisa can be stored in a secure location of the device executing the passport application. The device can retrieve the mVisa from the secure location and encrypt the mVisa including any associated keys. The device can then transmit the encrypted mVisa to the inspection system over the secure channel.

At 622, the inspection system can receive the mVisa from the device. For example, the inspection can receive an encrypted mDoc response from the device. The inspection system can decrypt the encrypted mDoc response and inspect the mVisa.

At 624, the inspection system can determine whether any child document is needed from the device. The child document can be, for example, a work permit or vaccination status card.

If the inspection system determines that the mTR is needed, it can send a request for the mTR at 626. For example, the inspection system can send another mDoc request to the device for the mTR. The mDoc request can be encrypted based on the encryption protocol and transmitted using the secure channel.

At 628, the device can transmit the requested mTR to the inspection system. For example, the device can retrieve the mTR from a secure location of the device. The device can further encrypt the mTR and transit the mTR as an mDoc response to the inspection system using the secure channel.

At 630, the inspection system can receive the mTR from the device. For example, the inspection system can decrypt the encrypted mTR and inspect the mTR for authentication.

At 632, the inspection system and/or the device can end this process and begin another process.

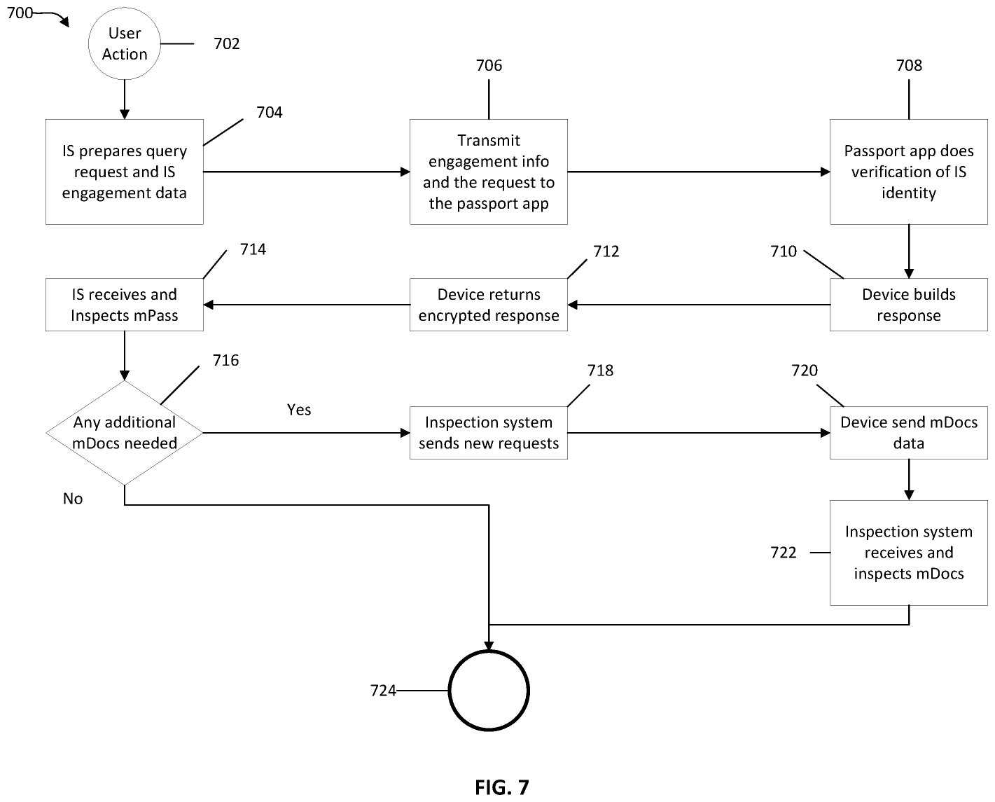

FIG. 7 is a process flow 700 for authenticating mobile documents on a device, according to one or more embodiments. At 702, the user can perform an action for initializing a passport application on a device, such as the mobile device 102 of FIG. 1. The action can be, for example, using a touch screen to manually touch a passport application icon displayed on the device.

At 704, the inspection system can prepare a request (e.g., a request for an mDoc such as the mPass) and prepares inspection system engagement data. The inspection system engagement data can include information for establishing a secure session between the device and the inspection system. For example, the engagement data can include information related to a handshake authentication, a challenge-response authentication, a password authentication, or other information to validate one another.

At 706, the inspection system can transmit the engagement information and the request to passport application executing on the device. The passport application can be operable for storing one or more mDocs used for traveling by a user.

At 708, the passport application can verify the inspection system's identity. For example, the passport application can be preconfigured with an identifier associated with the inspection system. The passport application can compare the preconfigured device identifier with a device identifier included in the engagement data.

At 710, the device can generate a response to the request from the inspection system. In response to receiving the request from the inspection system, the device can create an mDoc response message that includes the mPass and any necessary key information. For example, the mDoc response can include key information that the inspection system can use to verify the mPass. The device can further encrypt the response using an encryption protocol.

At 712, the device can return the encrypted response to the inspection system. For example, the device can transmit the encrypted mDoc response over the secure channel to the inspection system.

At 714, the passport application can receive the response from the device and can inspect the mPass. The response can be an mDoc response and include the mPass. The passport application can inspect the data elements included in the mPass to determine whether the mPass includes any required data elements and is associated with the user and the user device.

At 716, the inspection system can determine whether any other document is required. For example, the inspection can determine whether another mDoc such as an mTR is required for entry into the jurisdiction.

At 718, the inspection system can send a request for the additional document (e.g., mTR) from the device. The request can be based on the inspection system determining that the additional document is required. For example, the inspection can send a second mDoc request to the device. The second mDoc request can be encrypted pursuant to the encryption protocol and transmitted to the device over the secure channel.

At 720, the device can send the additional document to the inspection system. The additional document can be stored in a secure location of the device executing the passport application. The device can retrieve the additional document from the secure location and encrypt the document, including any associated keys. The device can then transmit the encrypted document to the inspection system over the secure channel.

At 722, the inspection system can receive the additional document from the device. For example, the inspection system can receive an encrypted mDoc response from the device. The inspection system can decrypt the encrypted mDoc response and inspect the additional document. For example, the inspection system can analyze one or more data elements of the additional document to determine whether the user can enter the foreign jurisdiction.

At 724, the inspection system and/or the device can end this process and begin another process.

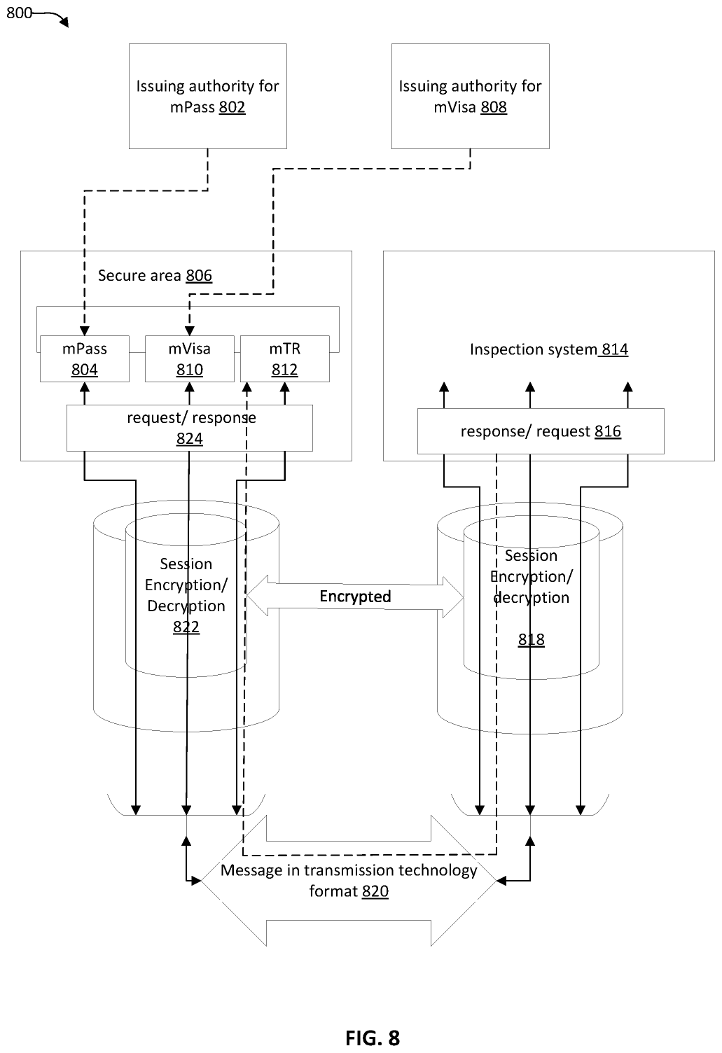

FIG. 8 is an illustration 800 of a data exchange of passport documents between a device and an inspection system, according to one or more embodiments. An issuing authority (e.g., governmental institution) for an mPass can provision an mPass 804 in a secure area 806 of a device, such as a mobile device. An issuing authority of an mVisa 808 (e.g., governmental authority) can provision an mVisa in the secure area 806 of the device. The secure area 806 can further store one or more mTR 812 (e.g., passport stamp work permit) provisioned by an authorized entity.

The mobile device and the inspection system can exchange messages (e.g., mDoc request and mDoc response) using a data format, such as a concise binary object representation (CBOR) or JavaScript object notation (JSON). In some embodiments, the data exchange illustrated in FIG. 8 and between the device and the inspection system can be as described in ISO/IEC 18013-5. CBOR can be a binary serialization format that is comparable with JSON. CBOR can allow the serialization to a binary format that can be smaller and faster to generate and parse, than JSON, by the device and the inspection system. It should be appreciated that other message exchange formats are possible.

An inspection system 814 can transmit a request 816 for a document to the device. For example, the inspection system can send a request for the mPass 804 to the device. The request 816 can be an mDoc request that is formatted pursuant to a data format (e.g., CBOR format). The request can undergo a session encryption process 818.

The encrypted request can be transmitted in the technology transmission format. As described, the device and the inspection system can communicate via various transmission protocols (e.g., using Bluetooth and/or Bluetooth LE standards, NFC, etc.). The device can process the request through a decryption process 822. The decrypted request 824 can be parsed by the device.

Based on the request, the device can generate a response 824 (e.g., mDoc response). The response 824 can be in a CBOR format. For example, if the request is for the mPass 804, the device can generate a mDoc response that includes the mPass 804. The device can encrypt the response using a session decryption process 822.

The encrypted response can be transmitted to the inspection system in the transmission technology format 820. The inspection system 814 can decrypt the encrypted response using a session decryption process 818. The inspection system 814 can analyze the decrypted response. For example, the inspection system 814 can receive the decrypted response in a CBOR format. The inspection system 814 can then analyze the data elements in the mPass 804 for a determination, such as for age verification or entry into a jurisdiction.

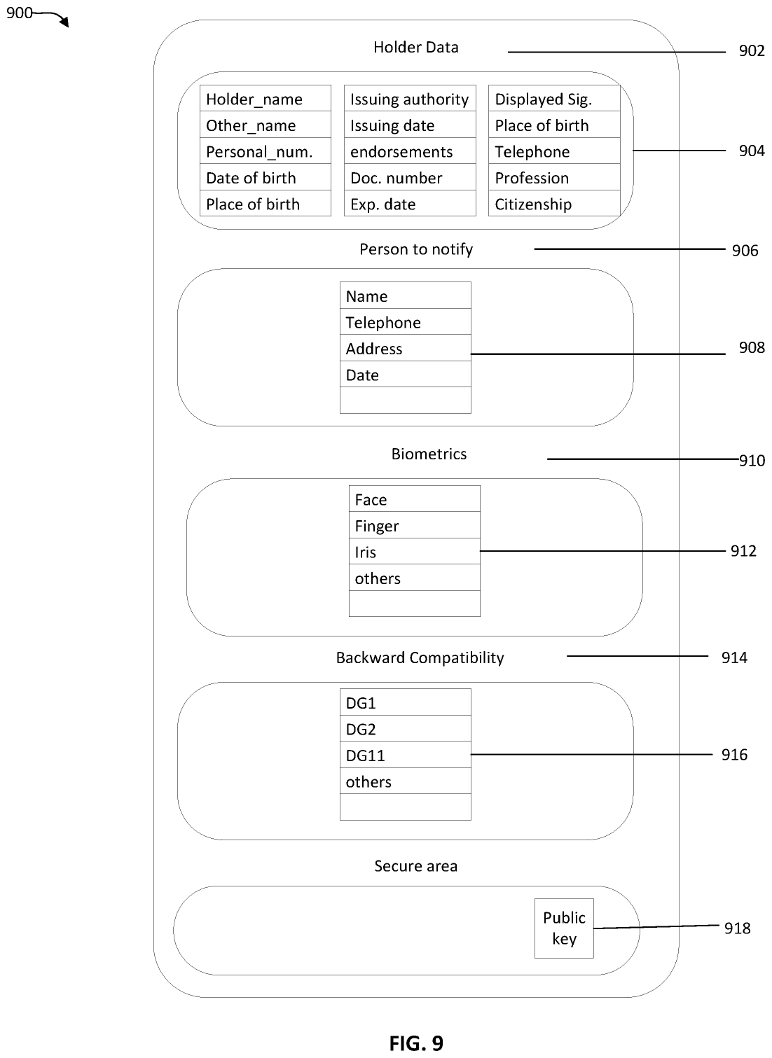

FIG. 9 is an illustration of data elements for an mPass 900, according to one or more embodiments. The mPass can include one or more namespaces that identify groups of data elements. Each data element can relate to information to be used to determine, for example to verify an age or identity or determine whether an individual can enter a jurisdiction. As illustrated, a first namespace 902, (e.g., holder data), can be associated with a first group of data elements 904 of identifying information of a passport holder. For example, the data elements can include a name (holder name), date of birth (date of birth), passport issuing authority (issuing authority), passport number (doc. number), holder signature (displayed sig.) and citizenship (citizenship). These data elements can be as defined in International Civil Aviation Organization (ICAO) document 9303-3 or other documents. It should be appreciated that additional data elements can be included in the first group of data elements 904. For example, the first group of data elements can include an age over xx data element, where the data element is as defined by ISO 18013-5. For example, the data elements can further include address, telephone number, profession, title, personal summary, other travel documents, custody information, observations, tax exit requirement, portrait specification, document code, nationality optional data, displayed portrait, and person to notify.

Furthermore, it should be appreciated that although an mPass is illustrated, that an mVisa and an mTR also can be organized similarly to the mPass. The mVisa data elements can include, for example, issuing organization, visa type, number of entries, duration of stay, passport number, territory information, place of issuance, issuance date, expiration date, document number, additional information, full name, primary identifier, secondary identifier, sex, date of birth, and nationality. The mTR data elements can include embarkation and debarkation state, visa approvals, data, inspection authority, inspector reference, mode of travel, duration of stay condition, and passport number.

A second namespace 906, (e.g., person to notify), can be associated with a second group of data elements 908 of emergency contact information. For example, the second group of data elements 908 can include an emergency contact name (name), an emergency contact telephone number (telephone), an emergency contact physical and/or email address (address), and date emergency contact established (date). The data elements in the second group of data elements can be as defined by ICAO document 9303-X.

A third namespace 910, (e.g., holder biometrics), can be associated with a third group of data elements 912 for biometric data. Each biometric data element can contain one of the user's biometric encoded as described in International Civil Aviation Organization document 9303, and not as a tag-length-value (TLV). This can be the equivalent of data group 2 (DG2) to DG4 biometric templates. The third group of data elements 912 can include a CBOR encoded structure corresponding to the face of the holder that can be input to a facial recognition system. Each biometric record can include multiple records with different biometric encodings. For example, the third group of data elements 912 can include face features (face), a fingerprint scan (fingerprint), an iris scan (iris), and other biometric data (others) that can be used to identify the holder. The data element for the face can be a facial image for use in machine assisted identity confirmation. If there are multiple recordings of the face, the most recent international interoperable can be the first entry.

A fourth namespace 914, (e.g., backward compatibility), can be associated with a fourth group of data elements 916 for backward compatibility. The fourth group of data elements 916 can contain data elements with content of the data groups (DGs) as defined by ICAO document 9303. For example, the fourth group of data elements 916 can include a data element for DG 1, DG2, DG11, and others (e.g., DG16). Each DG can be a logical grouping of data elements, which can be used to digitally store travel documents after they have been issued and during the documents validity period.

The mPass can further be associated with a public key 918. The public key can be generated by an issuing authority of the mPass.

In some embodiments, the device and the inspection system can implement security mechanisms as defined by ISO 18013-5. The security mechanisms can provide protection against forgery. Each of the mDocs can be signed by the issuing authority of the mDoc. The degree of protection against forgery can be based on the degree to which the issuer's key is protected. The security mechanisms can provide protection against cloning. The device can generate a signature over session data using a private key of the device. A corresponding inspection system with a public key can achieve trust in the device public key from the issuer signature. The degree of protection against cloning can be based on the degree to which the device private key is protected. The security mechanisms can protect against eavesdropping during transactions. Communication between a device and an inspection system can be encrypted and authenticated. For example, man in the middle style attacks can be detectable by the inspection system using validation of the digital signatures over session data. The security mechanism can provide inspection system authentication. For example, a reader certificate and a signature created by the reader using the corresponding private key. The reader certificate can be signed by a certificate authority trusted by the device.

In addition to the above-described security mechanisms, mDocs can be linked together based on two components: (1) an issuing authority signed passport number in both the parent (mPass) and child documents (mVisa, mTR), (2) a dynamic relationship between mDocs based on key derivation. In particular, child documents can have keys derived from parent keys.

First, the mVisa and the mTR can be linked to a specific mPass by including a document number (e.g., passport number) if the mPass has an issuing authority-signed data document number. The link based on the document number can be as strong as the document number.

Second, a device (e.g., mobile device, inspection system) can use a derivation function to generate a new child key (e.g., mVisa key, mTR key) from a parent key (e.g., mPass key). For a given child public key, a corresponding child private key can only be derived by the holder of the parent private key. Even if a bad actor came into possession of the parent public key and the corresponding child public key, the actor cannot derive the child private key with only these two keys. The actor can only derive the child private key with the parent private key. The link between a parent document and a child document can be verified using the relationship between the parent keys and the corresponding child keys.

Various derivation functions can be used to derive child keys from parent keys. A first derivation function can be used to generate a child public key from a parent public key. This can be used to allow an inspection system to issue a child document that is cryptographically linked to a parent document without having to verify a key attestation and a key proof of residency in a secure area of a mobile device. A second derivation function can be used to derive a child private key from a parent private key. In order to issue a new child document, a new public key can be calculated from the parent key (e.g., mPass key). The issuing authority of the child document can use a key derivation process to create a new public key. Furthermore, the authentication/session key establishment properties (e.g., elliptical curve Diffie-Hellman protocols for medium access control (MAC) algorithms, unforgeability of signature) as described in ISO 18013-5 can be preserved. The symmetric secret (SK) parameter can be collectively generated between the inspection system and the device.

Given a top level public/private key pair (we call it {d,P}) and a symmetric secret (SK), the device or inspection system can define two derivation integers {u_i, v_i}=KDF(SK, i). The device or inspection system can then perform the derivation of the public key as follows: P_i=u_i.P+v_i.G (where G is the generator point of the curve). The corresponding private key can be derived as: d_i=u_i*d+v_i. One can verify the correctness P_i==d_i.G.

For every new derivation, a new value for SK can be generated. If the SK is compromised (extracted), an adversary may be able to link keys together, but the adversary cannot perform an elliptical curve Diffie-Hellman (ECDH) key protocol, or sign with an elliptica curve digital signature algorithm (ECDSA), which allows device or inspection system to store the SK and derive the public key outside of the security domain handling the secret key,{d}.

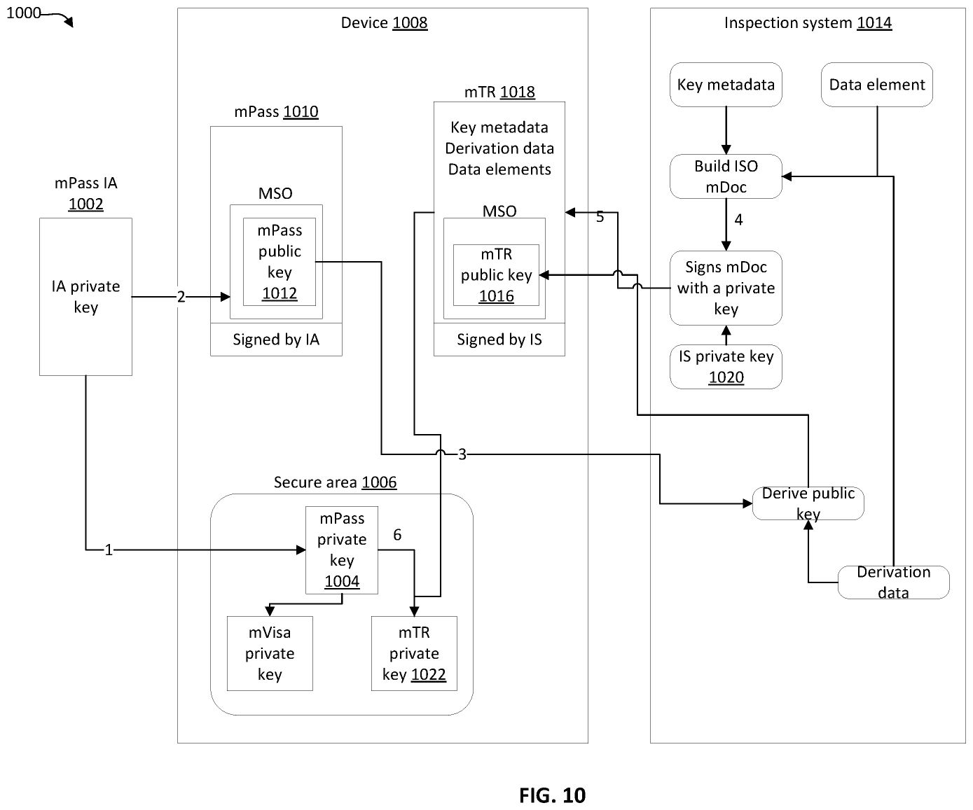

FIG. 10 is an illustration of a security mechanism for a mobile travel document, according to one or more embodiments. A verified key attestation can occur, in which the properties of the public key of an mPass and private key of the mPass can be verified. For example, an mPass issuing authority (IA) 1002 can verify that the mPass public key 1012 corresponds to the mPass private key 1004 stored in secure area of a device 1008 (e.g., mobile device). Based on the verification, the mPass IA can provision the device 1008 with an mPass 1010. The mPass 1010 can include the previously verified mPass public key 1012 in the mPass MSO, where the MSO is a data structure signed by the mPass issuer. This steps can occur when a user is having the mPass IA 1002 provision the mPass 1010 on the device 1008.

Eventually, the user will want to use the mPass 1010 to, for example, verify age, verify identity, or enter a foreign jurisdiction. The user can use the device 1008 to initiate a secure session with an inspection system (IS) 1014. Part of the purpose of the secure session can be, for example, to receive a passport stamp. For example, the user can present their device 1008 to an inspection system 1014, for example at an airport or shipping port of a foreign jurisdiction, to get stamped. The inspection system 1014 can retrieve the mPass public key 1012, use derivation data, and apply a derivation function to establish a new public key 1016. The new public key 1016 can be used for an mTR 1018 (e.g., passport stamps) that is provisioned on the device 1008 by the inspection system 1014. The mTR can include information related to the derivation function in addition to the stamp data, such as key metadata, derivation data, and data elements. The inspection system 1014 can further sign the mTR, including the key metadata, derivation data, data elements with an IS private key 1020. The public key corresponding to the IS private key 1020 can be used to verify the mTR 1018. Therefore, a subsequent inspection system (e.g., user travels to yet another country) can use a public key to verify the authenticity of the mTR based on the signature included in the mTR 1018, where this public key corresponds to the IS private key 1020.

The device can use derivation data included in the mTR in addition to the parent private key 1004 and derive an mTR private key 1022. The derived private key 1022 can be used in subsequent transactions to prove the mTR has not been cloned and stored on the device. For example, if the mTR 1018 had been cloned and stored on a new device, the signature of the mTR 1018 may be verified by the IS using the mTR issuer public key. However, the new device will not have access to the mTR private key 1022, as that mTR private key 1022 can only be derived on the original device 1008

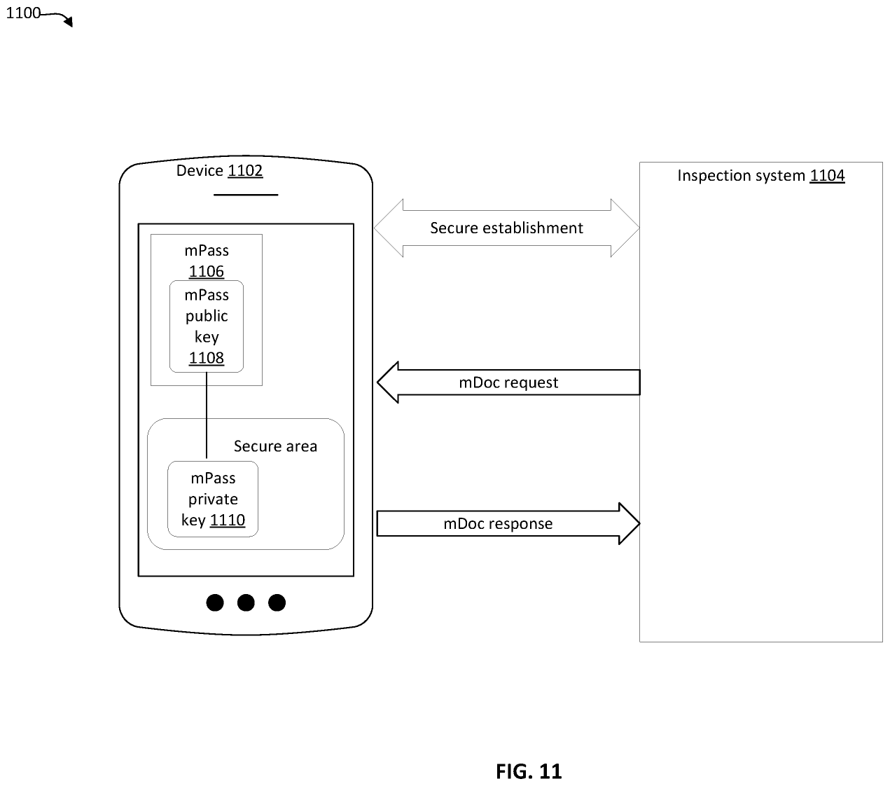

FIG. 11 is an illustration of a request and response sequence for travel documents, according to one or more embodiments. A device 1102 and an inspection system 1104 can use a short-range transmission protocol to establish a secure session with each other. The short-range transmission protocol can be, for example, NFC, Bluetooth, or Wi Fi.

The inspection system 1104 can send a request, such as an mDoc request, to the device 1102 for an mPass 1106. For example, the inspection system can be setup for entry into a foreign jurisdiction that requires a passport for entry. The mPass 1106 can include an mPass public key 1108 that corresponds to an mPass private key 1110. The mPass public key 1108 can have been signed by an issuing authority of the mPass 1106. The mPass private key can be stored in a secure area of the device 1102.

The device 1102 can sign the mPass 1106 using the mPass private key 1110 and transmit the mPass 1106 to the inspection system 1104. In some embodiments, the transmission can be an mDoc response that is encrypted and formatted using a CBOR format.

The inspection system 1104 can receive the mPass 1106 over a secure channel from the device 1102. The inspection system 1104 can further decrypt the message from the device 1102. The inspection system 1104 can trust the mPass public key 1108 because it has been signed by the mPass issuing authority. The inspection system 1104 can further use the mPass public key 1108 to verify the device's signature. Based on verifying the device's signature, the inspection system 1104 can verify that the mPass was originally issued to the same device presenting it and begin to inspect the data elements included in the mPass 1106.

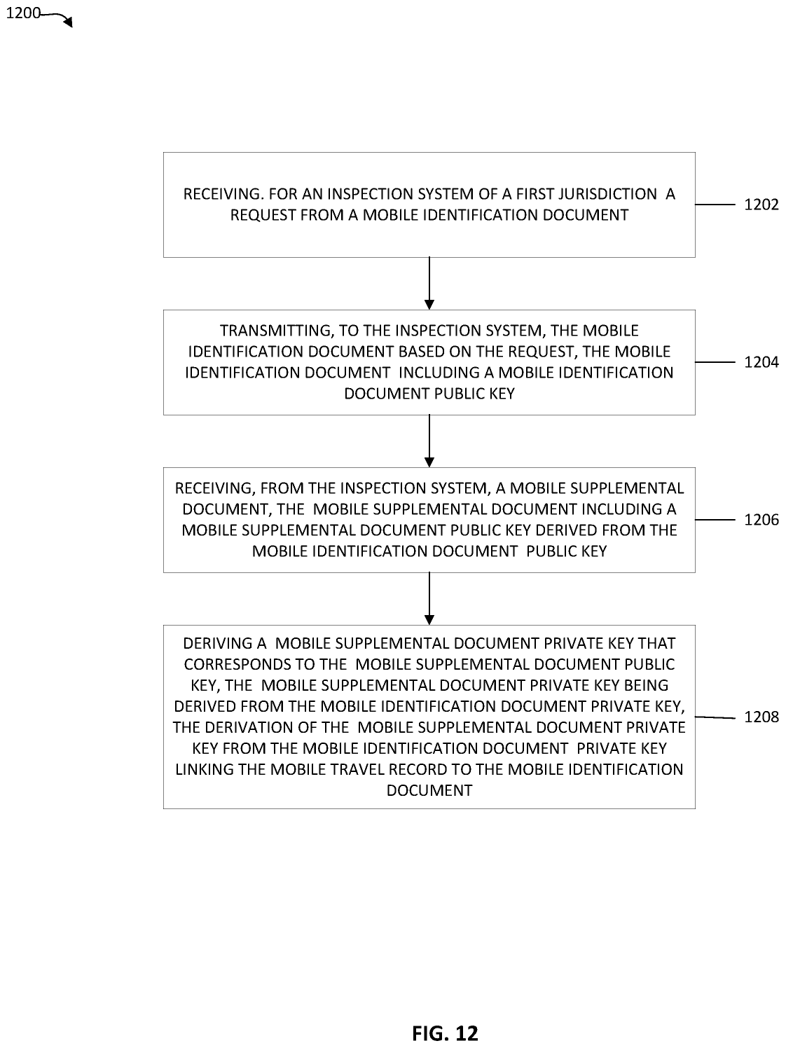

FIG. 12 is a process flow 1200 for linking a mobile supplemental document to a mobile identification document, such as a mobile passport, according to one or more embodiments. At 1202, the method can include a user device receiving, from an inspection system of a first jurisdiction, a request for a mobile identification document of a second jurisdiction, the user device comprising a mobile identification document private key. The user device can be a mobile device of the user. The first jurisdiction can be, for example, a destination country and the second jurisdiction can be, for example, an origination country. The process can be initialized by a passport application executing on the user device. The user device and the reader can establish contact when within the proximity and communicate with each other using a short range transmission protocol, such as NFC, Bluetooth, or Wi Fi.

At 1204, the method can include the user device transmitting, to the inspection system, the mobile identification document based at least in part on the request, the mobile passport comprising a mobile identification document public key. In some embodiments, the user is provided an opportunity to manually input whether to provide or not provide the mobile identification document to the inspection system. The transmission can be based on receiving this consent.

At 1206, the method can include the user device receiving, from the inspection system, a mobile supplemental document, such as a mobile travel record, the mobile supplemental document comprising a mobile supplemental document public key derived from the mobile identification document public key, the inspection system being configured to derive the mobile supplemental document public key from the mobile identification document public key. The mobile supplemental document can be, for example, a work permit, a passport stamp or other travel related document. The inspection system can have received the mobile identification documentpublic key and used a key derivation function to derive the mobile supplemental document public key.

At 1208, the method can include the user device deriving a mobile supplemental document private key that corresponds to the mobile supplemental document public key, the mobile supplemental document private key being derived from the mobile identification document private key, the derivation of the mobile supplemental document private key from the mobile identification document private key linking the mobile supplemental document to the mobile identification document. The user device can use a key derivation function to derive the mobile supplemental document private key. The mobile supplemental document private key as well as the mobile identification document private key can be stored in a secure area of the user device and separate from the mobile identification document and the mobile supplemental document. In this sense only the device has access to either private key. Therefore, if the mobile identification document and/or the mobile supplemental document is cloned and stored on another device, the new device will not have access to the private key and will fail authentication by a subsequent inspection system.

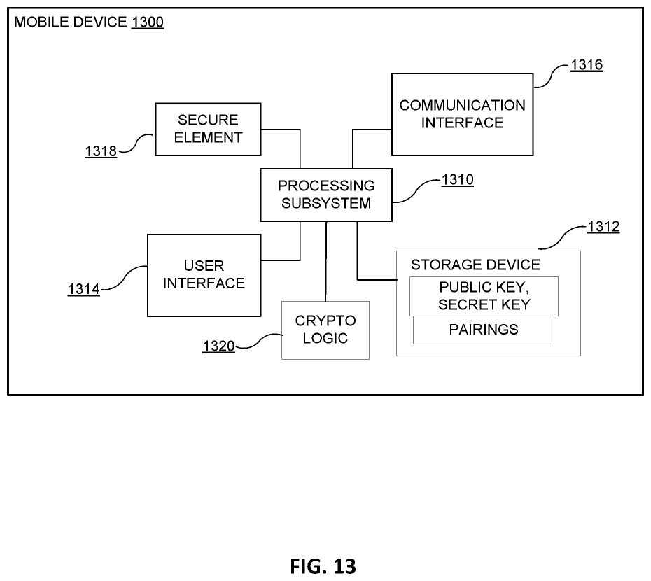

FIG. 13 is a block diagram of a mobile device 1300 according to some embodiments. Mobile device 1300 can implement any or all of the mobile device functions, behaviors, and capabilities described herein, as well as other functions, behaviors, and capabilities not expressly described. Mobile device 1300 can include processing subsystem 1310, storage device 1312, user interface 1314, communication interface 1316, secure element 1318, and cryptographic logic module 1320. Mobile device 1300 can also include other components (not explicitly shown) such as a battery, power mobile devices, and other components operable to provide various enhanced capabilities. In various embodiments, mobile device 1300 can be implemented in a desktop computer, laptop computer, tablet computer, smart phone, wearable computing device, or other systems having any desired form factor.

Storage device 1312 can be implemented, e.g., using disk, flash memory, or any other non-transitory storage medium, or a combination of media, and can include volatile and/or nonvolatile media. In some embodiments, storage device 1312 can store one or more application and/or operating system programs to be executed by processing subsystem 1310, including programs to implement any or all operations described herein as being performed by a mobile device. For example, storage device 1312 can store a uniform mobile device application that can read an accessory definition record and generate a graphical user interface for controlling the accessory based on information therein. In some embodiments, portions (or all) of the mobile device functionality described herein can be implemented in operating system programs rather than applications. In some embodiments, storage device 1312 can also store apps designed for specific accessories or specific categories of accessories (e.g., a passport application).

User interface 1314 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital to analog or analog to digital converters, signal processors, or the like). A user can operate input devices of user interface 1314 to invoke the functionality of mobile device 1300 and can view and/or hear output from mobile device 1300 via output devices of user interface 1314.

Processing subsystem 1310 can be implemented as one or more integrated circuits, e.g., one or more single core or multi core microprocessors or micromobile devices, examples of which are known in the art. In operation, processing system 1310 can control the operation of mobile device 1300. In various embodiments, processing subsystem 1310 can execute a variety of programs in response to program code and can maintain multiple concurrently executing programs or processes. At any given time, some or all of the program code to be executed can be resident in processing subsystem 1310 and/or in storage media such as storage device 1312.

Through suitable programming, processing subsystem 1310 can provide various functionality for mobile device 1300. For example, in some embodiments, processing subsystem 1310 can implement various processes (or portions thereof) described above as being implemented by a mobile device. Processing subsystem 1310 can also execute other programs to control other functions of mobile device 1300, including programs that may be stored in storage device 1312. In some embodiments, these programs may interact with an accessory, e.g., by generating messages to be sent to the accessory and/or receiving messages from the accessory. Such messages can conform to a uniform accessory protocol as described above.

Communication interface 1316 can provide voice and/or data communication capability for mobile device 1300. In some embodiments communication interface 1316 can include radio frequency (RF) transceiver components for accessing wireless voice and/or data networks (e.g., using cellular telephone technology, data network technology such as 3G, 4G/LTE, 5G, Wi Fi (IEEE 802.11 family standards), or other mobile communication technologies, or any combination thereof), components for short-range wireless communication (e.g., using Bluetooth and/or Bluetooth LE standards, NFC, RFID, Wi Fi etc.), and/or other components. In some embodiments communication interface 1316 can provide wired network connectivity (e.g., Ethernet) in addition to or instead of a wireless interface. Communication interface 1316 can be implemented using a combination of hardware (e.g., driver circuits, antennas, modulators/demodulators, encoders/decoders, and other analog and/or digital signal processing circuits) and software components. In some embodiments, communication interface 1316 can support multiple communication channels concurrently, using the same transport or different transports.

Secure element 1318 can be an integrated circuit or the like that can securely store cryptographic information (e.g., secure area) for mobile device 1300. Examples of information that can be stored within secure element 1318 include the mobile device's long term public and secret keys, and a list of paired accessories (e.g., a lookup table that maps accessory ID to accessory long term public key for accessories that have completed a pair setup or pair add process as described above).

In some embodiments, cryptographic operations can be implemented in a cryptographic logic module 1320 that communicates with secure element 1318. Physically, cryptographic logic module 1320 can be implemented in the same integrated circuit with secure element 1318 or a different integrated circuit (e.g., a processor in processing subsystem 1310) as desired. Cryptographic logic module 1320 can include various logic circuits (fixed or programmable as desired) that implement or support cryptographic operations of mobile device 1300, including any or all cryptographic operations described above. Secure element 1318 and/or cryptographic logic module 1320 can appear as a “black box” to the rest of mobile device 1300. Thus, for instance, communication interface 1316 can receive a message in encrypted form that it cannot decrypt and can simply deliver the message to processing subsystem 1310. Processing subsystem 1310 may also be unable to decrypt the message, but it can recognize the message as encrypted and deliver it to cryptographic logic module 1320. Cryptographic logic module 1320 can decrypt the message (e.g., using information extracted from secure element 1318) and determine what information to return to processing subsystem 1310. As a result, certain information can be available only within secure element 1318 and cryptographic logic module 1320. If secure element 1318 and cryptographic logic module 1320 are implemented on a single integrated circuit that executes code only from an internal secure repository, this can make extraction of the information extremely difficult, which can provide a high degree of security. Other implementations are also possible.

Thus, although specific embodiments have been described, it will be appreciated that embodiments may include all modifications and equivalents within the scope of the following claims.

As described above, one aspect of the present technology is the provisioning of mobile travel documents on a device. The present disclosure contemplates that in some instances, this gathered data may include personal information data that uniquely identifies or may be used to identify a specific person. Such personal information data may include demographic data, telephone numbers, email addresses, home addresses, data or records relating to a user's passport or related documents, date of birth, or any other personal information.

The present disclosure recognizes that the use of such personal information data, in the present technology, may be used to the benefit of users. For example, the personal information data may be used to authenticate a user identity. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only (e.g., travel to and from a foreign jurisdiction). Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain biometric data may be governed by federal and/or state laws; whereas biometric data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For example, the present technology may be configured to allow users to select to “provide” or “not provide” travel documents to an inspection system. In addition to providing “provide” and “not provide” options, the present disclosure contemplates providing notifications relating to the access or use of personal information. For instance, a user may be notified upon using an app clip that their passport data will be accessed and then reminded again just before passport data is accessed by the app.

Some or all of these techniques may, but need not, be implemented at least partially by as those shown at least in FIGS. 1-13 above. While many of the embodiments are described above with reference to computing devices and user devices, it should be understood that other types of computing devices may be suitable to perform the techniques disclosed herein. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various embodiments further can be implemented in a wide variety of operating environments, which in some cases can include one or more user computers, computing devices or processing devices that can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle®, Microsoft®, Sybase®, and IBM®

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, mobile device, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium that can be used to store the desired information and that can be accessed by the a system device. Based at least in part on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a,” “an,” and “the,” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based at least in part on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method, comprising:
receiving, by a user device and from an inspection system, a request for a mobile passport, the user device having stored thereon a mobile passport private key;
transmitting, by the user device and to the inspection system, the mobile passport based at least in part on the request, the mobile passport comprising a mobile passport public key;
receiving, by the user device and from the inspection system, a mobile supplemental document, the mobile supplemental document comprising a mobile supplemental document public key derived from the mobile passport public key, the inspection system being configured to derive the mobile supplemental document public key from the mobile passport public key;
deriving, by the user device, a mobile supplemental document private key that corresponds to the mobile supplemental document public key, the mobile supplemental document private key being derived from the mobile passport private key; and
linking, by the user device, the mobile supplemental document to the mobile passport based at least in a part on the derivation of the mobile supplemental document private key from the mobile passport private key.

2. The method of claim 1, wherein the method further comprises:
determining whether user consent has been provided to transmit the mobile passport to the inspection system; and
transmitting the mobile passport based at least in part on the determination.

3. The method of claim 1, wherein the request for the mobile passport is a sequential request for the mobile passport and a mobile visa, and wherein the method further comprises transmitting the mobile passport and the mobile visa to the inspection system based at least in part on the sequential request.

4. The method of claim 1, wherein the request comprises a first request, and wherein the method further comprises:
transmitting the mobile passport to the inspection system based at least in part on the first request;
receiving a second request, subsequent to the first request, for a mobile visa; and
transmitting the mobile visa based at least in part on the second request.

5. The method of claim 1, wherein the mobile supplemental document comprises a mobile passport number associated with the mobile passport, wherein the mobile passport number further links the mobile supplemental document to the mobile passport.

6. The method of claim 1, wherein the method further comprises storing the mobile passport private key and the mobile supplemental document private key in a secure location of the device.

7. The method of claim 1, wherein the inspection system is associated with a first jurisdiction and the mobile passport is associated with a second jurisdiction.

8. The method of claim 1, wherein the mobile supplemental document is a mobile travel record.

9. A user device, comprising:
a processor; and
a computer-readable medium including instructions that, when executed by the processor, cause the processor to perform operations comprising:
receiving, from an inspection system, a request for a mobile passport the user device having stored thereon a mobile passport private key;
transmitting, to the inspection system, the mobile passport based at least in part on the request, the mobile passport comprising a mobile passport public key;
receiving, from the inspection system, a mobile supplemental document, the mobile supplemental document comprising a mobile supplemental document public key derived from the mobile passport public key, the inspection system being configured to derive the mobile supplemental document public key from the mobile passport public key;
deriving a mobile supplemental document private key that corresponds to the mobile supplemental document public key, the mobile supplemental document private key being derived from the mobile passport private key; and
linking the mobile supplemental document to the mobile passport based at least in part on the derivation of the mobile supplemental document private key from the mobile passport private key.

10. The user device of claim 9, wherein the instructions that, when executed by the processor, further cause the processor to perform operations comprising:
determining whether user consent has been provided to transmit the mobile passport to the inspection system; and
transmitting the mobile passport based at least in part on the determination.

11. The user device of claim 9, wherein the request for the mobile passport is a sequential request for the mobile passport and a mobile visa, and wherein the instructions that, when executed by the processor, further cause the processor to perform operations comprising transmitting the mobile passport and the mobile visa to the inspection system based at least in part on the sequential request.

12. The user device of claim 9, wherein the request comprises a first request, wherein the instructions that, when executed by the processor, further cause the processor to perform operations comprising:
transmitting the mobile passport to the inspection system based at least in part on the first request;
receiving a second request, subsequent to the first request, for a mobile visa; and
transmitting the mobile visa based at least in part on the second request.

13. The user device of claim 9, wherein the mobile supplemental document comprises a mobile passport number associated with the mobile passport, wherein the mobile passport number further links the mobile supplemental document to the mobile passport.

14. The user device of claim 9, wherein the instructions that, when executed by the processor, further cause the processor to perform operations comprising storing the mobile passport private key and the mobile supplemental document private key in a secure location of the device.

15. The user device of claim 9, wherein the inspection system is associated with a first jurisdiction and the mobile passport is associated with a second jurisdiction.

16. The user device of claim 9, wherein the mobile supplemental document is a mobile travel record.

17. A non-transitory computer-readable medium having stored thereon a sequence of instructions that, when executed by a processor, causes the processor to perform operations comprising:
receiving, from an inspection system, a request for a mobile passport;
transmitting, to the inspection system, the mobile passport based at least in part on the request, the mobile passport comprising a mobile passport public key;
receiving, from the inspection system, a mobile supplemental document, the mobile supplemental document comprising a mobile supplemental document public key derived from the mobile passport public key, the inspection system being configured to derive the mobile supplemental document public key from the mobile passport public key;
deriving a mobile supplemental document private key that corresponds to the mobile supplemental document public key, the mobile supplemental document private key being derived from a mobile passport private key; and
linking the mobile supplemental document to the mobile passport based at least in part on the derivation of the mobile supplemental document private key from the mobile passport private key.

18. The non-transitory computer-readable medium of claim 17, wherein the mobile passport is a mobile passport, and wherein the instructions that, when executed by the processor, further cause the processor to perform operations comprising:
determining whether user consent has been provided to transmit the mobile passport to the inspection system; and
transmitting the mobile passport based at least in part on the determination.

19. The non-transitory computer-readable medium of claim 17, wherein the request for the mobile passport is a sequential request for the mobile passport and a mobile visa, and wherein the instructions that, when executed by the processor, further cause the processor to perform operations comprising transmitting the mobile passport and the mobile visa to the inspection system based at least in part on the sequential request.

20. The non-transitory computer-readable medium of claim 18, wherein the mobile supplemental document comprises a mobile passport number associated with the mobile passport, wherein the mobile passport number further links the mobile supplemental document to the mobile passport.
